(19) United States
(12) Patent Application Publication
(10) Pub. No.: US 2009/0317051 A1
(43) Pub. Date: Dec. 24, 2009

(54) Mobile Timestamp Systems and Methods of Use

(76) Inventor: Daniel K. Millington, Castle Rock, CO (US)

Correspondence Address: Leyendecker & Lemire, LLC, C/O PORTFOLIO IP, P.O. BOX 52050, MINNEAPOLIS, MN, 55402, US

(21) Appl. No.: 12/486,623

(22) Filed: Jun. 17, 2009

Related U.S. Application Data
(60) Provisional application No. 61/132,252, filed on Jun. 18, 2008.

(51) Int. Cl. H04N 5/93; H04N 5/225

(52) U.S. Cl. 386/52; 348/207.1; 348/376; 348/E05.024

(57) ABSTRACT

Computer-based systems and methods are disclosed for generating video clips for specific events. The system comprises at least a server, a video capture device, the video capture device being operatively coupled to the server, and one or more mobile timestamp devices, the one or more mobile timestamp device being removably coupled to the server. A first mobile timestamp device is a small device comprising a button and an interface that can reside in a user's hand. The button can be depressed to make timestamps after which it reverts back to its original extended position. A second mobile timestamp device can be a PDA having a software application adapted to collect a variety of data in conjunction with the timestamps. Video clips are generated by the system relating to event indications of specific events as identified by software.

### CROSS REFERENCE TO RELATED APPLICATIONS

The present application claims priority to U.S. Provisional Application No. 61/132,252 filed on Jun. 18, 2008 having the same named inventor. The parent application is incorporated herein by reference.

### FIELD OF THE INVENTION

The present invention relates generally to systems and methods for generating video clips. More particularly, the present invention relates to a systems and methods for generating video clips for specific events during a larger video recording.

### BACKGROUND

With the abundance of video recording devices and relatively inexpensive recording media, obtaining a video of an event is not a problem that needs to be solved. However, with the ease and ability to capture so much video, a new problem arises. Finding relevant portions of a long video recording becomes a problem for persons wishing to view a specific event contained therein. Many times it is more desirable and necessary to watch a long video recording from start to finish. However, when there is a particular reason to view the specific event and a person or persons viewing the specific event have limited time to spend to watch it, the process of fast forwarding and rewinding the long video recording at various speeds becomes cumbersome and tedious.

For example, in amateur sports, coaches, assistants, and referees/umpires involved with amateur sports are typically volunteers or receive nominal compensation for their time. While their passion for the sport and desire to teach and assist others compels them to utilize recorded video to help amateur athletes improve, coaches often do not have enough time (or in many cases is it necessary) to view the video of an entire game. Hence, it is often desirable to view only a specific event as a teaching moment relating to a good or bad play. Similarly, a referee may wish to review another specific event to review whether a call was or was not properly made. Unlike in professional or semi-professional sports, it is not practical to stop play to review a certain play for determination during the game, however, the availability for review of a specific event after the game is extremely helpful.

Additionally, when coaches, assistants, and referees/umpires are actively participating in a game, it is challenging for them to indicate specific events during the course of that game because they are so involved. Hence, they may not have any effective indications of specific events that happened during the course of the game for later review of a video recording without recalling from memory the time of the specific event or writing a notation on paper or in a notebook. For instance, a coach is typically in the heat of the action, either communicating with the players, assistants, and/or referees when a particular event occurs for which he or she wishes to review at a later time. Further, it may be impracticable and dangerous for a referee or umpire to make an indication or notation of a particular event during the course of game. Take the situation of amateur hockey, for instance, when a referee sees a particular play for which he believes there may be a penalty, but decides that it is too close to call. The referee wishes to review that specific play to determine whether he was correct to let the game continue, but cannot stop the game to make a notation as the play continues and he would risk missing another play as well as injury should he divert his attention to make the notation. Further, even if a stopwatch were used to indication at what time the particular event occurred, such an indication would necessitate the cumbersome and tedious process of fast forwarding and rewinding through the long video recording.

Although the problems of time to review and difficulty of notation/indication are framed in the context amateur sports and those actively participating in such an event, the desirability of concise video recordings within a longer recorded video, and the problems associated with obtaining such a concise video recording, is one that many persons (e.g., parents wishing to produce short video clips of their children's participating in a sporting event or larger production to sent to friends and family) face. Heretofore, the ability for coaches, assistants, referees, umpires, parents, and/or other similarly situated persons to easily identify relevant portions of a long video recording and obtain concise video clips thereof does not satisfactorily exist.

### SUMMARY OF THE DRAWINGS

FIG. 1 is a block diagram illustrating an exemplary architecture of a system for generating video clips of specific events according to one embodiment.

FIG. 2A is a plan view of a first variation of a mobile timestamp device according to one embodiment.

FIG. 2B is a plan view of a second variation of a mobile timestamp device according to one embodiment.

FIG. 3 is a block diagram of an exemplary computer system as can be utilized in various embodiments.

FIG. 4 is an exemplary screen shot of a main menu screen of a software application adapted to generate video clips of specific events according to one embodiment.

FIG. 5 is an exemplary screen shot of an event trigger screen as can be created from data acquired from a first mobile timestamp device according to one embodiment.

FIG. 6 is an exemplary screen shot of a new game screen as can be displayed on a second mobile timestamp device according to one embodiment.

FIG. 7 is an exemplary screen shot of a video backup screen according to one embodiment.

FIG. 8 is an exemplary screen shot of a video clip according to one embodiment.

FIG. 9 is a flow chart illustrating one method for generating video clips of specific events according to the present invention.

FIG. 10 is a perspective view of an action scene in a hockey game exemplary of the systems and methods according to one embodiment.

### DETAILED DESCRIPTION

The systems and methods of embodiments of the present invention provide ways to generate video clips of longer video recordings with ease and precision. An exemplary system adapted to generate video clips of a specific event typically comprises a video capture device, one or more video cameras, a server, one or more software applications, and a mobile timestamp device. With the aid of the mobile timestamp device, specific events for which the video clips are generated can be indicated without diverting one's attention from the action of a game. Various embodiments of the mobile timestamp device meet specific needs of a person utilizing systems and methods. For instance, one exemplary mobile timestamp device includes a single button, which can be activated or triggered one or more times to indicate a particular event. One trigger of the button can signify a first event type, two triggers of the button with a short time period between each trigger can signify a second event type, and three triggers with a short time period between each trigger can signify a third event type. In another exemplary mobile timestamp device, a software application can be loaded onto a personal digital assistant device or similar type device wherein additional details regarding a specific event can accompany the trigger. A plurality of event timestamps can be triggered on a single mobile timestamp device.

In an exemplary method, the mobile timestamp device is synchronized with the server. The server is further synchronized with the video capture device, thereby synchronizing the mobile timestamp device with the video capture device. When the exemplary method is used during the recording of a live event, the one or more cameras are coupled to the video capture device. The video capture device can be adapted to capture video simultaneously from the one or more video cameras to provide a plurality of views of the recorded event. Further, the video capture device can be adapted to provide video copy or backup for the recorded video in a self-executing video file. The video capture device is operatively coupled to the server and responsive to instructions therefrom. The server accesses a plurality of software modules and/or program instructions adapted to: (i) synchronize the mobile timestamp recorder with the video capture device, (ii) receive and store one or more event data entries from the mobile timestamp device, (iii) receive and store one or more time parameters associated with each event type, and (iv) request a customized copy or backup from the video capture device for each of the one or more event indications with the associated one or more time parameters.

In use, the mobile timestamp device is triggered by a user to identify a specific event for which the user wishes to obtain a video clip. The trigger activity used to identify the specific event can also provide information related to the nature of the event type.

### Terminology:

The terms and phrases as indicated in quotation marks (“ ”) in this section are intended to have the meaning ascribed to them in this Terminology section, applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to: “one embodiment”; “an embodiment”; “another embodiment”; “an alternative embodiment”; “one variation”; “a variation”; and similar phrases mean that a particular feature, structure, or characteristic described in connection with the embodiment or variation, is included in at least an embodiment or variation of the invention. The phrase “in one embodiment,” “in one variation,” or similar phrases, as used in various places in the specification, are not necessarily meant to refer to the same embodiment or the same variation.

The term “couple” or “coupled,” as used in this specification and the appended claims, refers to either an indirect or direct connection between the identified elements, components or objects. Often the manner of the coupling will be related specifically to the manner in which the two coupled elements interact.

The term “video clip” as used in this specification and the appended claims, refers to relatively short intervals of a stored representation of visual imagery. Examples of video clips include, but are not limited to, intervals of recorded video in either digital or analog format. Further, content of video clips may include, but is not limited to, sporting events, news events, music videos, television programs, feature films, online videos, and homemade videos.

The term “self-executing video file” as used in this specification and the appended claims, refers to a file comprising video content that is encapsulated with an executable video player software application. For example, but not by way of limitation, a self-executing video file may be a computer file with a self-contained executable procedure (.exe) that when opened will start a video player and play the video content.

The term “personal digital assistant device” as used in this specification and the appended claims, refers to any type of personal digital assistant (“PDA”) device capable of storing and executing customized applications. Examples of personal digital assistant devices include, but are not limited to, a Blackberry, an iPhone, a Palm Treo, etc.

The term “removable storage device” as used in this specification and the appended claims, refers to any of a device capable of interfacing with a computer and receiving and storing computer files. Computer files on the removable storage device are typically, but not necessarily, transferred to another computer. Examples of removable storage devices include, but are not limited to, a USB flash drive and other NAND-type flash memory data storage devices, a USB memory card, a UBS mass storage device, and a removable hard drive.

### One Embodiment of a System and Method for Generating Video Clips of Specific Events

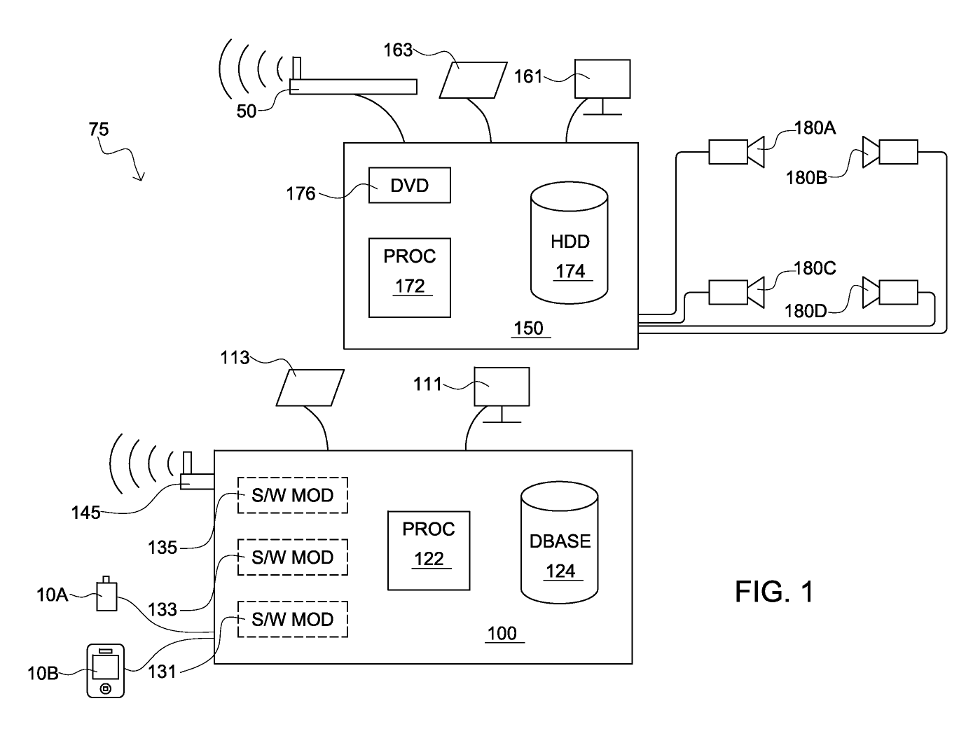

An exemplary computer-based system according to one embodiment of the present invention is illustrated in the block diagram of FIG. 1. For the sake of brevity, conventional data networking applications and other computer science functional embodiments of the exemplary system and components thereof may not be described in significant detail herein as would be obvious to one of ordinary skill in the art. System 75 generally comprises a server 100, a video capture device 150, and at least one mobile timestamp device (10a and 10b) removably coupled to the server. The video capture device 150 is operatively coupled to the server 100. In one embodiment, a wireless router 50 provides the necessary connectivity between the video capture device 100 and the server, although other computer networking methods such as, but not limited to, a direct Ethernet cable connection, local and/or wide area networks, the Internet, and combinations thereof are contemplated. Additionally, when recording a video of a live event, one or more video cameras (180a, 180b, 180c, and 180d) are included as part of the system 75.

Server 100 typically comprises a processor 122, one or more databases 124, a display 111, a data entry device 113, and a plurality of software modules and interfaces. The data entry device 113 provides a way to enter data into the server 100 and the display 111 provides a display output for the various display screens generated by the server 100. The one or more databases 124 comprise software components, such as a structured collection of record or data and associated indexing catalog, and hardware components, such as a hard disk drive and other physical memory storage. The processor 122 receives instructions from a plurality of software modules such as but, not limited to, a remote timestamp interface software module 131, an event indication software module 133, and a remote communications software module 135. Server 100 can include a transceiver 145, which can be used to communicate with other devices and systems such as the wireless router 50 and the video capture device 150.

The video capture device 150 typically comprises a processor 172, a hard disk drive 174, a DVD burner 176, a display 161, a data entry device 163, and a plurality of software modules and interfaces. Additionally, video capture device 150 can interface with the one or more video cameras (180a, 180b, 180c, and 180d) to capture video of an event being recorded. The hard disk drive 174 is typically a 160 GB hard drive, however larger hard drives to store significantly video recordings can be added to the video capture device 150 if, for instance, additional video cameras or a greater amount of video is required to be recorded. The DVD burner 176 can be used if an entire download of a recorded video is desired as can be requested via the data entry device 163 or otherwise. Additional set-up of the video capture device 150, particularly respect to set-up and interface of the one or more video cameras (180a, 180b, 180c, and 180d) can be accomplished with the aid of the data entry device 163 and the display 161.

In one embodiment, the one or more video cameras (180a, 180b, 180c, and 180d) can comprise 4.3 millimeter infrared lenses. The lenses of the one or more video cameras (180a, 180b, 180c, and 180d) are typically designed to be pre-focused. Embodiments of the system 75 are, of course, not limited by any particular camera type, however, it is worthy to note that the pre-focused feature is the easiest to set up and install prior to the event or game and requires no additional adjustment throughout the course of the event.

The plurality of software modules of the server 100 are adapted to: (i) synchronize the mobile timestamp recorder (10a and 10b) with the video capture device 150, (ii) receive and store one or more event data entries from the mobile timestamp device (10a and 10b), (iii) receive and store one or more time parameters associated with each event type, and (iv) request a customized copy or backup from the video capture device 150 for each of the one or more event indications with the associated one or more time parameters. Furthermore, an event indication software application enables users of the systems to manage server 100 by utilizing the functionality associated with one or more of the remote timestamp interface software module 131, the event indication software module 133, and the remote communications software module 135. The event indication software application can create a database record comprising an event indication, which can include a timestamp and associated information related to the event indication. One or more database records comprising one or more event indications can be gathered from one or more event data entries recorded by one or more mobile timestamp device (10a and 10b).

As would be obvious to one of ordinary skill in the art, server 100 can comprise a variety of systems and components, beyond those specifically identified in FIG. 1 necessary to accomplish the various tasks associated with generating video clips of specific events. It is pertinent to note that while the system 75 shown in FIG. 1 typically employs a client/server architecture, embodiments are not limited to any particular architecture and could equally well find application in a distributed, or peer-to-peer architecture system.

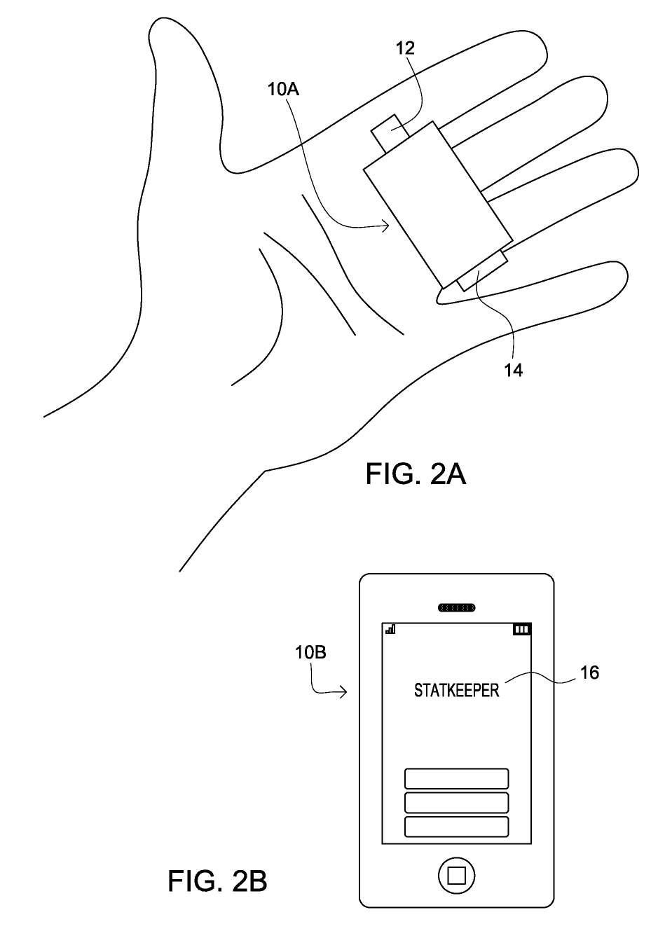

Two variations of the mobile timestamp device (10a and 10b) are illustrated in FIG. 2A and FIG. 2B, respectively. Mobile timestamp devices (10a and 10b) are adapted to record data, the data including one or more timestamps, representing one or more points in time identifying one or more specific events in order to obtain video clips of each of the identified specific events.

Referring to FIG. 2A, a first mobile timestamp device 10a is a small device typically comprising a button 12 and an interface 14. Additionally, the first mobile timestamp device 10a typically comprises a housing, a battery, circuitry including a time clock circuit, and a memory. The time clock circuit provides an internal clocking mechanism that produces a real time clock reference. Data can be transferred from the clock circuit to the memory. The button 12 can be depressed after which it reverts back to its original extend position. However, any type of switch adapted to activate or trigger the first mobile timestamp device 10a may be used. When the button 12 is depressed or triggered in any way, a timestamp is created by the time clock circuit and stored in the memory. Further, a tone generator may be included in the circuitry of the first mobile timestamp device 10a and with the addition of a small speaker an audible tone can be generated when the button 12 is depressed or triggered.

The memory of the first mobile timestamp device 10a can be a removable storage device or can be hardwired in the circuitry of the device itself. When the memory is of the removable storage device variety, the removable storage device may be removed from the first mobile timestamp device 10a and inserted or placed into a computer system or device. For instance, computer systems and devices such as, but not limited to, the server 100 and the video capture device 150 (FIG. 1) can include a port adapted to receive removable storage devices. When the memory is of the hardwired variety, the memory can be comprised of a non-volatile memory chip and, with interface 14, data stored on the memory can be transferred to a computer system or device.

The interface 14 is typically, but not necessarily, a USB interface. In other variations, the interface 14 of the first mobile timestamp device 10a may comprise wireless communications means adapted to communicate with one or more of the elements of the system such as the server 100 or the video capture device 150 (FIG. 1).

Still referring to FIG. 2A, the first mobile timestamp device 10a can reside in a user's hand or attached via a strap to the user's arm. Moreover, it can be secured to the user by various methods including being fastened to the user's clothing or hung around the user's neck. When the first mobile timestamp device 10a is held in the user's hand, a strap (not viewable from the perspective of FIG. 2A) is typically used to fasten the first mobile timestamp device 10a on the hand. Additionally, the first mobile timestamp device 10a can be combined with a whistle or another companion object or apparatus.

In some variations, the first mobile timestamp device 10a can be adapted from a tipping bucket rain gauge. The typical tipping bucket rain gauge comprises two small tipping buckets mounted on a fulcrum that activate a small switch when one of the two small tipping buckets becomes full. When the one of the two small tipping buckets becomes full, its weight causes it to tip thereby activating the small switch and emptying itself as the other tipping bucket pivots into place to receive rain. The activation of the small switch causes electronic circuitry to record the event as an amount of rainfall collected by the tipping bucket. The button 12 of the first mobile timestamp device 10a may be added (replacing the two tipping buckets and fulcrum assembly) whereby a manual depressing of the button 12 will record the event as a timestamp.

FIG. 2B illustrates a second mobile timestamp device 10b according to one embodiment of the systems and methods. The second mobile timestamp device 10b can be a PDA having a software application adapted to collect a variety of data in conjunction with the timestamps. For example, a StatKeeper software application can be loaded onto the PDA. The StatKeeper software application provides a plurality of screens that allow data to be entered via a keyboard and/or a touch-screen and stored in the PDA. A startup screen 16 is typically, but not necessarily, displayed on a display of the PDA when the StatKeeper software application is started. In one embodiment, the StatKeeper software application is created with Microsoft Visual FoxPro enabling it to be loaded onto a variety of PDAs.

The mobile timestamp devices (10a and 10b) are adapted to record or capture one or more event data entries. With respect to the first mobile timestamp device 10a, the only event data entries captured are timestamps triggered when the user depresses the button 12 to indicate the occurrence of one or more specific events and the timestamp thereof. Typically, but not necessarily, the timestamps are made in a format of YYYY.MM.DD.HH.MM.SS, wherein YYYY is a numerical representation of the year, MM is a numerical representation of the month, DD is a numerical representation of the day of the month, HH is a numerical representation of the hour in 24-hour time format, MM is a numerical representation of the minutes, and SS is a numerical representation of the seconds. Similarly, the format of YYYY.MM.DD.HH.MM.SS is typically used in conjunction with a timestamp of the second mobile timestamp device 10b. However, additional data fields comprising information relating to the specific event identified by the timestamp can be entered when the second mobile timestamp is used by a user. Further, the additional data fields can be cross-referenced at a later time to obtain one or more very specific video clips.

It is to be appreciated that the first mobile timestamp device 10a and/or the second mobile timestamp device 10b, as well as alternate embodiments and variations thereof, may be by used with various embodiments of the system and methods.

### An Exemplary Computer System

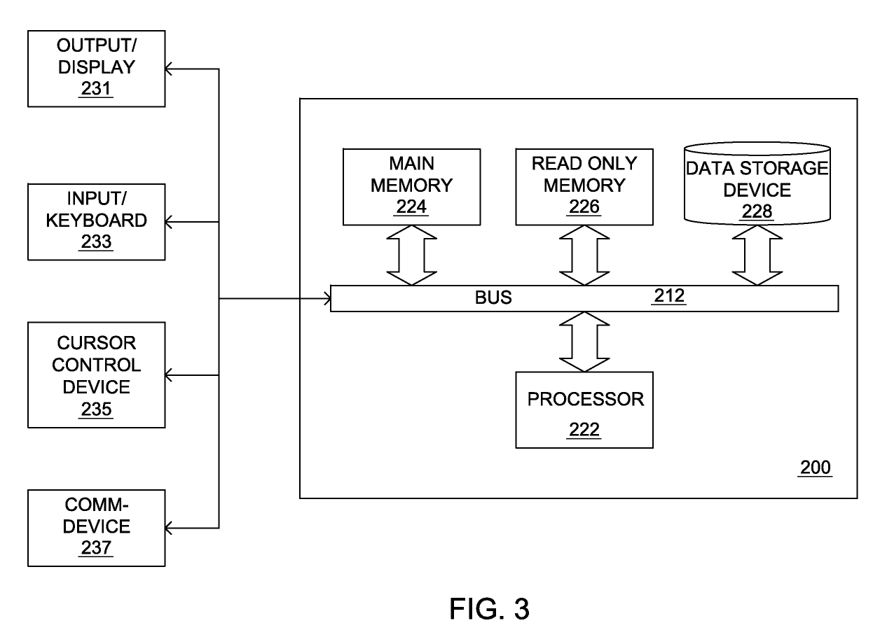

FIG. 3 illustrates an exemplary general purpose computer system upon which embodiments of the present invention can be implemented. The computer system 200 comprises a bus or other communications means 212 for communicating data or information, and a processing means such as a processor 222. The computer system 200 further comprises a random access memory (RAM) or other similar dynamically-generated data storage device 224 (referred to as main memory in FIG. 3 and hereinafter). The main memory 224 is coupled to the bus 212 for storing information and instructions to be executed by the processor 222. Additionally, the main memory 224 can be used for storing temporary variables or other intermediate information during execution of instructions by the processor 222. The computer system 200 also comprises a read only memory (ROM) and/or other static storage device 226 coupled to the bus 212 for storing static information and instructions for the processor 222.

A data storage device 228 such as, but not limited to, a solid state drive or an optical disk drive can also be coupled to the bus 212 as a component of the computer system 200 for storing data and instructions. The computer system 200 can also be coupled via the bus 212 to an output or display device 231, such as but not limited to a cathode ray tube (CRT) on liquid crystal display (LCD) for displaying information to a user. Typically, an input device such as an alphanumeric keyboard 233, including alphanumeric, symbol, and other keys can be coupled to the bus 212 for communicating information and/or command selections to the processor 222. Another type of user input device is a cursor control device 235, such as a mouse, trackball, or cursor direction keys for communicating information and/or command selections to the processor 222 and for controlling cursor movement on the display 231.

The computer system 200 can also include a communications device or interface 237. Communications device 237 can be coupled to the bus 212 and allows data and software to be transferred between the computer system 200 and external networks and devices. Examples of communications device 237 include a modem, a network interface card, a wireless network interface card, or other well-known interface device, such as those used for Ethernet, token ring, asynchronous transfer mode (ATM), or other types of physical attachment for purposes of providing a communications link to support a local or wide area network. In this manner, the computer system 200 can be coupled to a number of clients and/or servers via a conventional network infrastructure, such as and intranet and/or the Internet, for example.

It is appreciated that a lesser or more equipped computer system than the example described above can be desirable for certain implementations of the system of the present invention. Therefore, the configuration of the computer system 200 will vary from implementation to implementation depending on numerous factors such as price constraints, performance requirements, technological improvements, and/or other circumstances.

It is pertinent to note that, while the operation described herein can be performed under the control of a programmed processor, such as the processor 222 in FIG. 3, in alternative embodiments, the operations can be fully or partially implemented by any programmable or hard-coded logic, such as but not limited to field programmable gate arrays (FPGAs), TTL logic, application specific integrated circuits (ASICs), for example. Additionally, the methods of the embodiments can be performed by any combination of programmed general purpose computer components and/or custom hardware components. Therefore, nothing disclosed herein should be construed as limiting the present invention to a particular embodiment wherein the recited operations are performed by a specific combination of hardware components.

As would be obvious to one skilled in the art of computer science and systems engineering, many variations and alternate embodiments of the systems described above can be used with embodiments of the present invention. The plurality of systems and software modules can be stored in any one of a number of internal and external storage devices, remotely or centrally located, as those of skill in the art could easily adapt one embodiment computer architecture to a multitude of embodiments. Furthermore, a system for making, using, or selling the embodiments can be one or more processing systems including, but not limited to, servers, a central processing unit, memory, storage devices, input/output devices, communication links and devices, or any modules or components of the one or more processing system including by way of example, but not limitation, software, firmware, hardware, or any combination thereof.

### Exemplary Use of a System and Method for Generating Video Clips of Specific Events

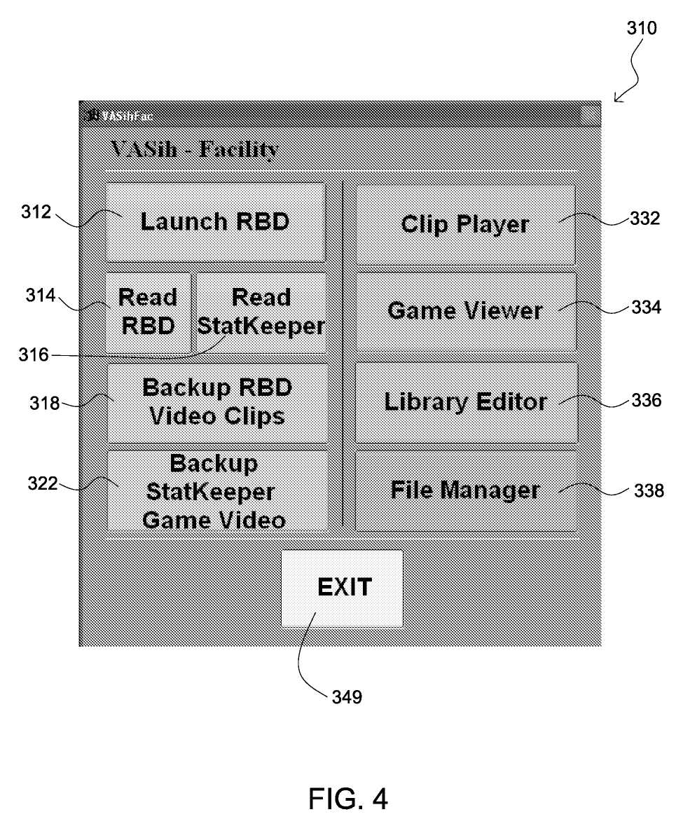

FIG. 4 is an exemplary screen shot of a main menu of a software application adapted to generate video clips of specific events according to one embodiment as would typically be run on the server 100. The exemplary use of the system 75 described herein is provided in a hockey context whereby certain screens of the event indication software application and other aspects of the system 100 are customized to use while recording specific events during a hockey game. However, embodiments can be customized for use in a variety of other recorded events, sporting or otherwise. Main menu screen 310 displays a plurality of soft buttons adapted to cause the processor 122 to execute various functions with the server 100 and the system 75 as a whole (referring back to FIG. 1). The main menu screen 310 can include a Launch RBD button 312, a Read RBD button 314, a Read StatKeeper button 316, a Backup RBD Video Clips button 318, a Backup StatKeeper Game Video button 322, a Clip Player button 332, a Game Viewer button 334, a Library Editor button 336, a File Manager button 338, and an Exit button 349.

The Launch RBD button 312 when clicked pulls up a screen that permits a user to launch a referee bench device (RBD). The RBD is a hand held device and exemplary of the first mobile timestamp device 10a (FIG. 2A) in one embodiment. When the user launches the RBD, the server 100 can synchronize an internal clocking mechanism of the RBD. The internal clocking mechanism of the processor 172 of the video capture device 150 (FIG. 1) can be automatically or manually synchronized with the server 100, if any deviation from the server 100 is noted. The RBD, which is removably coupled to the server 100, should be coupled with the server 100 at the time when it is launched. Similarly, the RBD should be coupled to the server 100 when clicking on the Read RBD button 314. When clicked, the Read RBD button 314 pulls up a screen that enables the user to stop logging event data entries on the RBD. The one or more event data entries can then be downloaded (essentially one or more timestamps when using the RBD) and are stored as database records of event indications in the server's one or more databases 124 (FIG. 1). Likewise, the Read StatKeeper button 316 when clicked enables the one or more event data entries to be downloaded from the second mobile timestamp device 10b (as shown in FIG. 2B). However, event data entries collected and the subsequent database records of event indications recorded utilizing the second mobile timestamp device 10b can include a variety additional information/data fields in conjunction with the timestamp, such as, but not limited, to a type of event, a person involved in the event, and a location of the person involved in the specific event.

Still referring to FIG. 4, the Backup RBD Video Clips button 318 when clicked causes the server 100 to generate one or more video clips related to the events identified on the first timestamp device 10a. Similarly, the Backup StatKeeper Game Video 322 when clicked causes the server 100 to generate one or more video clips related to the events identified on the second mobile timestamp device 10b. The process of creating copies or backups in order to generate one or more video clips related to one or more specific events will be discussed in more detail later in this specification.

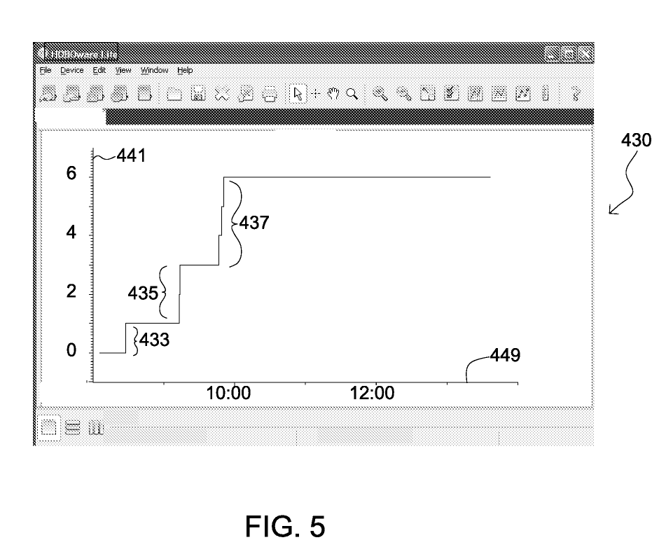

Also of note on the main menu screen 310 are several graphical buttons encompassing important functions. The Clip Player button 332 when clicked pulls up a screen allowing the user to sort and pick a subset of the one or more video clips from a plurality of games, whereas the Game Viewer button 334 when clicked pulls up a screen allowing the user to sort and pick a subset of full length game clips, typically used with StatKeeper data sets. The Library Editor button 336 when clicked pulls up a screen allowing the user to access the complete database of video clips and stored data. The File Manager button 338 when clicked pulls up a file management screen, such as, but not necessarily, Microsoft File Explorer so that the user can clear and move the files of the server 100 contained therein. And finally, the Exit button 349 when clicked exits the FIG. 5 is an exemplary screenshot of an event trigger screen shot according to one embodiment. Referring back momentarily to FIG. 4, after the Read RBD button 314 is clicked, the user may be able to view a graphical representation of the one or more event data entries. An event trigger screen 430 provides that graphical display. A vertical axis 441 indicates the count of depressions to the button 12 of the first mobile timestamp device 10a (FIG. 2A). A horizontal axis 449 indicates the elapsed time. Hence, information can be obtained from each inflection relating to the count of depressings of the button 12 and the time elapsed between each depressing.

For instance, a single depressing of the button 12 can signify an event type “A” 433. Depressing the button 12 two time can signify an event type “B” 435, wherein there is a short time period between the first depressing of the button 12 and a second depressing of the button 12. Depressing the button 12 three consecutive times can signify an event type “C” 437, wherein there is a short time period between a first depressing of the button 12 and a second depressing of the button 12, and a short time period between the second depressing of the button 12 and a third depressing of the button 12. In one embodiment, the length of the short time period between a previous depressing of the button 12 and a subsequent depressing of the button 12 is typically designated as three seconds to be interpreted as coding of an event type. If the subsequent depressing of the button 12 exceeds three seconds the subsequent timestamp is interpreted as a new, independent event code and evaluated with the next following pressing of the button 12 for determining the event type. However, it should be noted that the short time period is not limited to three seconds and may be adjusted depending on the context of the event for which timestamps are being recorded.

The user may designate in the event indication software application a specific event type associated with event type “A” 433, event type “B” 435, and event type “C” 437. For example, in one embodiment, event type “A” 433 can indicate a goal, event type “B” 435 can indicate a shot on goal, and event type “C” can indicate a penalty. It is to be appreciated that embodiments are not limited to any number of event types as a large number of event types can be uniquely indicated by a count of consecutive of depressings of the button 12. Furthermore, the one or more event data entries graphically displayed on the event trigger screen 430 are analyzed in their textual format with use of the event indication software module 133 (FIG. 1) of the event indication software application.

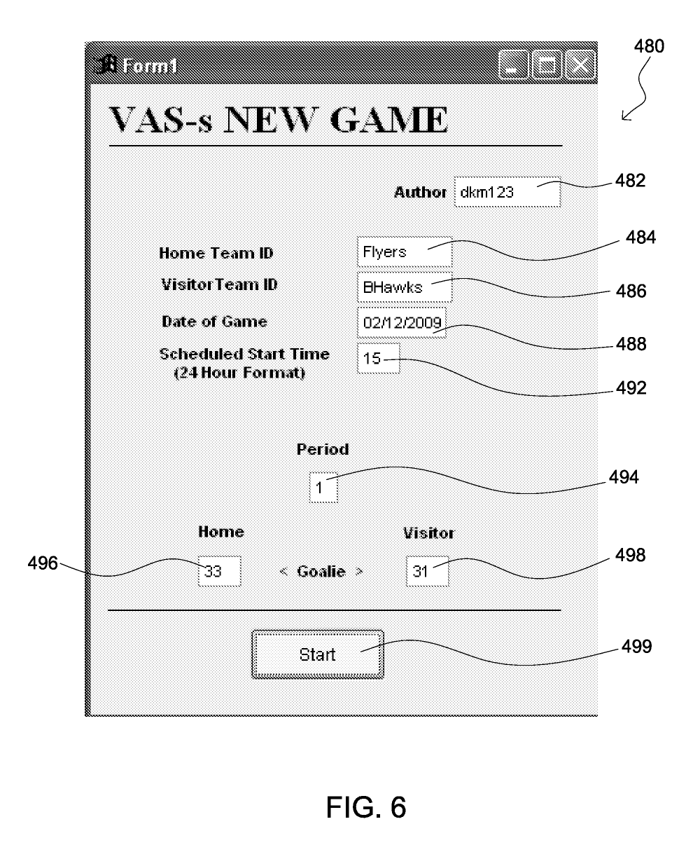

Now referring to FIG. 6, an exemplary screen shot of a new game screen shown on the second mobile timestamp device 10b is illustrative of the additional detail fields which can be entered and used to obtain one or more very specific video clips. In one embodiment, the StatKeeper software application is adapted to enter data related to a hockey game. A new game screen 480 provides fields for which the user can enter data such as, but not limited to, an author 482, a home team 484, a visitor team 486, a date of game 488, a scheduled start time 492, a period 494, a home team goalie 496, and a visiting team goalie 498. The data in the field of the new game screen 480 can be entered (and the game started) when a Start button 499 is clicked by the user. For example, a new game can be created in the StatKeeper application by entering an author, a home team ID, a visitor team ID, a data of the game, a scheduled start time, a period, a home goalie, and a visitor goalie among other information into a new game screen. This basic game data is recorded on all game records and is included with a timestamp as one or more event data details when entering data into the second mobile timestamp device 10b.

Additional screens (not shown) of the StatKeeper software application, such as main indication screen are adapted to record timestamps associate with specific events of interest such as, but not limited to, a goal, a shot on goal, a puck drop, an infraction, a stoppage, a change of periods, and a change of goalie. Moreover, when a timestamp is created for the shot on goal specific event, a shot position screen adapted to identify the position from which the shot was taken can be displayed. Additionally, a goal screen is adapted to allow for additional goal data to be entered including a first player number of a player who scored the goal, a second player number of a player who made an assist on the goal (if any), and a third player number of a player who also made an assist on the goal (if any). The shot position and goal information can be added to the data comprising the timestamp for the specific event. Similarly, a penalty and stoppage screen contains a list of common penalties such as, but not limited to, charging, cross checking, elbowing, fighting, high sticking, and holding, and a list of come common stoppages such as, but not limited to, hand pass, icing, net off, off sides, and puck out of play.

The one or more event data details, such as but not limited to the information and data points described above, can be included when making one or more data entries as recorded by the second timestamp device 10b to provide information toward ascertaining one or more event indications and can further be cross referenced at a later time to obtain one or more very specific video clips.

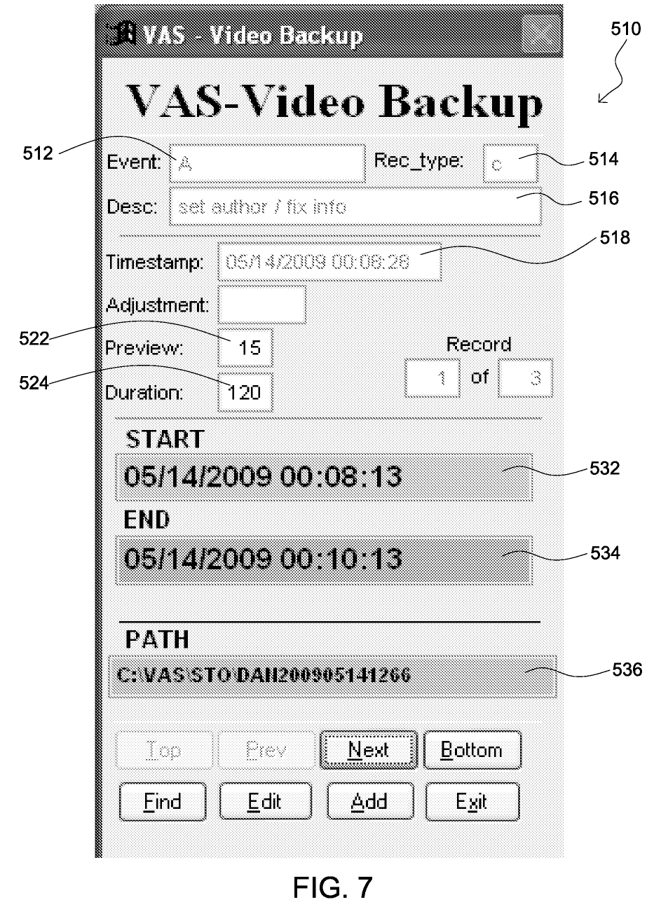

FIG. 7 is an exemplary screen shot of a video backup screen according to one embodiment. After the Backup RBD Video Clips button 318 has been clicked, a video backup screen 510 provides fields for which the user can enter data and/or fields for which data may be pre-populated by the event indication software application such as, but not limited to, an event 512, a record type 514, a description of the copy or backup 516, a timestamp 518, a preview time 522, a duration time 524, a start time 532, an end time 534, and a file path 536. The timestamp 518 identified on the video backup screen 510 serves as an event time for the copy or backup being requested for the specific event. As described earlier with the aid of the in FIG. 5, one or more event data entries, which themselves include a timestamp can be used to identify an event type. Thus, a timestamp recorded with an event data entry may or may not be used as the event time from which to start a copy or backup as determined by the event indication software application.

Still referring to FIG. 7, the preview time 522 is a time parameter indicating an amount of time prior to the event time that should be included in the copy or backup. The duration time 524 is a time parameter indicating a total amount of time for the event that should be included in the copy or backup. Each of these time parameters may contain a value previously entered from the author's profile for the specific event type. Moreover, in some embodiments, the video clips may be automatically generated and stored in by requests from the server 100 as copies or backups from the video capture device when the first mobile timestamp device 10a or the second mobile timestamp device has been read by the server 100 by clicking on clicking on the Read RBD 314 or Read StatKeeper 316 (FIG. 4), respectively.

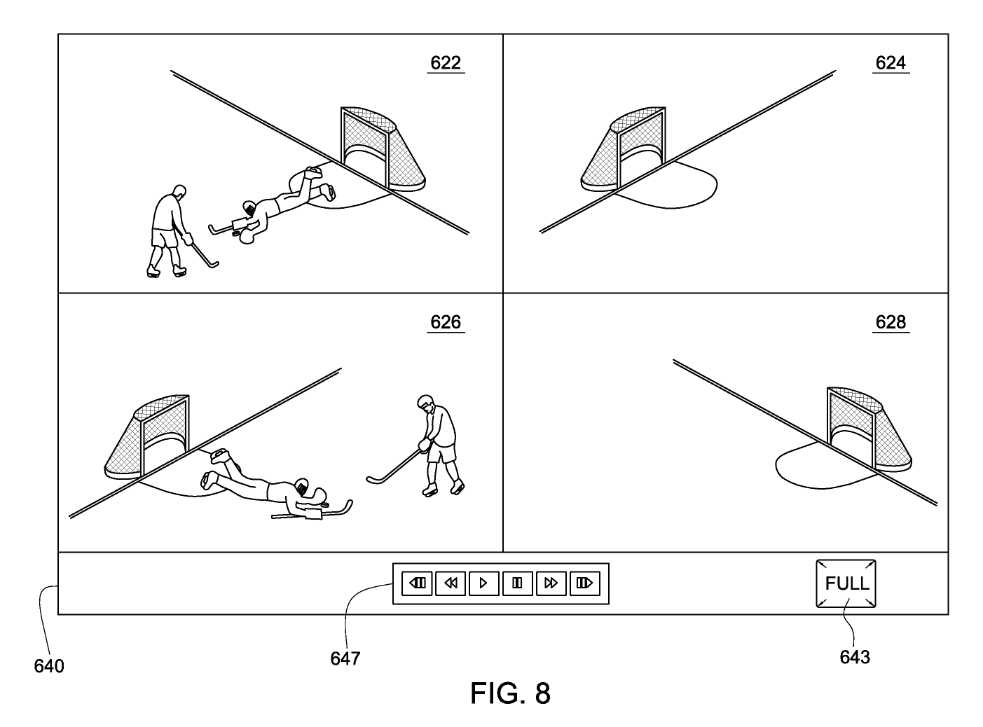

FIG. 8 is an exemplary screen shot of a video clip according to one embodiment. A video clip 620 is illustrated with four video views typically simultaneously recorded: a camera one view 622, a camera two view 624, a camera three view 626, and a camera four view 628. The video clip 620 displayed in FIG. 8 is exemplary of video provided by a self-executing video file. A video clip control panel 640 of an embedded video player is displayed at the bottom of the video clip 620. A navigation panel 647 of the video clip control panel 640 can be adapted to provide various fast forwarding, rewinding, pausing, and playing functionality in the form of one or more buttons selectable by the user. Moreover, the user may select anyone of the four aforementioned views for a single enlarged view by clicking one of the four views and a full screen button 643.

It should be noted that embodiments of the present invention include various functions and storing of data relating to system 75 generally and the server 100 beyond the views, fields, and buttons described above and as shown on the exemplary screen shots.

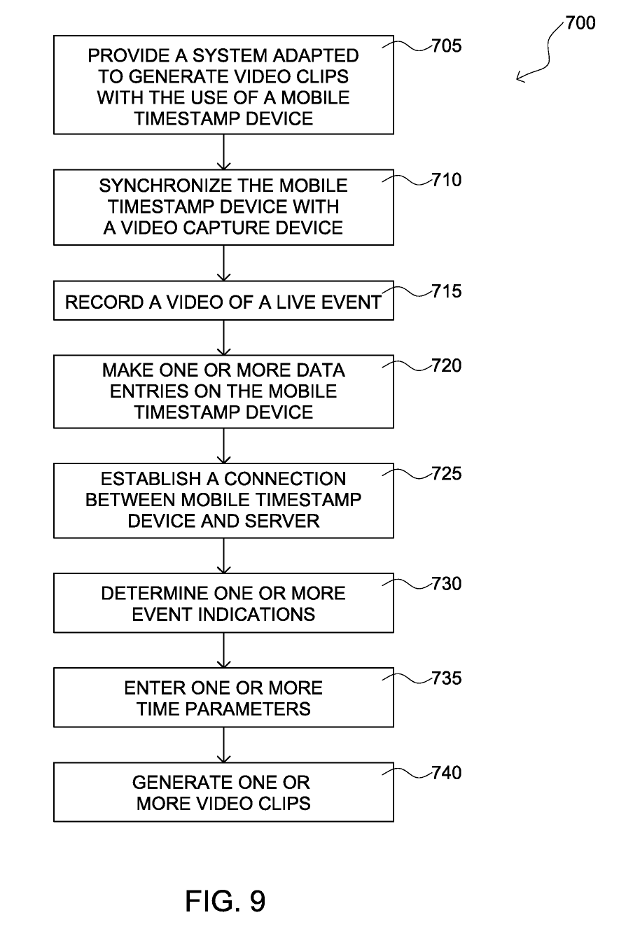

A method 700 of using system 75 in accordance with the inventive concept of generating video clips for specific events is illustrated with reference to FIG. 9. The method 700 can be used with the embodiments and variations for the system 75 and one or more mobile timestamp devices (10a and 10b) as described in specification and figures (primarily FIGS. 1, 2A, & 2B) above.

The method includes an operation 705 of providing a system 75 in to enable the method described herein. System 75 is adapted to generate video clips relating to specific events for which a user wished to review. The one or more video clips generated by the system 75 with use of the method 700 are typically short versions of a longer recorded event. Next as described in operation 710, one or more mobile timestamp devices (10a and 10b) are synchronized with the video capture device 150. The synchronization is typically accomplished when the one or more mobile timestamp devices (10a and 10b) are coupled to the server 100. For instance, the first mobile timestamp device 10a can be connected to the server 100 via its USB port 14. Furthermore, after the one or more mobile timestamp devices (10a and 10b) have been synchronized, the physical connection with the server 100 can be severed and the one or more mobile timestamp devices (10a and 10b) can be taken and used anywhere in accordance with the method 700.

An operation 715 of recording a live event can be included in the method 700. If recording a live event, one or more video cameras (180a, 180b, 180c, and 180d) are typically included as part of the system 75 and are operatively coupled to the video capture system 150. The method 700 of using system 75 is particularly useful when the user is part of the live action as the first mobile timestamp device allows him or her to actively participate in the event while identifying specific and pertinent events for which video clips can be generated and reviewed.

Next, as described in operation 720, the user can make one or more event data entries on the mobile timestamp device (10a and 10b). If the user is utilizing the first mobile timestamp device 10a in conjunction with the method 700, then the one or more event data entries can be made by various depressions of the button 12 each creating a timestamp. However, if the user is utilizing the second mobile timestamp device 10b in conjunction with the method 700, then the one or more event data entries can comprise additional information in conjunction with a timestamp. The one or more event data entries are eventually collected by the server either in real-time if connectivity to the server is continuous with the server or after establishing a connection.

Another operation 725 includes establishing a connection between the mobile timestamp device (10a and 10b) and the server 100. This operation 725 is typically, but not necessarily, done after the user has completed making the desired one or more event data entries. Next, as described in operation 730, the server 100 determines the existence of one or more event indications. The server 100 collects the one or more event data entries and stores them in its database 124. The one or more event indications can be determined by analysis of the one or more event data entries. For instance, referring briefly back to FIG. 5, the event indication software module 133 can determine an occurrence of the event type “C” 437 by detecting three consecutive timestamp event data entries. It is pertinent to note that the server 100 can collect one or more event data entries from a plurality of mobile timestamp devices (10a and 10b) and stores the one or more event data entries in its database 124 such that each user's one or more event indications are determined and categorized by utilizing the author data field.

An operation 735 can be performed whereby the user enters one or more time parameters associated with one or more event types. The one or more time parameters can include, but are not limited to, the duration prior to an event time and a duration after the event time. While default parameters may exist, the user is given the flexibility of entering the one or more time parameters specific to each event type. For example, a first time parameter indicating the duration prior to the event time can be entered as two minutes and a second time parameter indicating the total clip duration can be entered as two minutes and 30 seconds for the event type “C” by the user. The first and second time parameters as described in the example above can be unique to the particular user (designated as the author in the software of the system 100), and other users can designate different values for the first and second time for their event types.

Next, as described in operation 740, one or more video clips can be generated by the system 75. The one or more video clips are typically generated by having the server 100 request a customized backup from the video capture device 150. The request from the server 100 can comprise a start and stop time for the customized backup calculated from the event time and the one or more time parameters for the specific event type. The user can select only a subset of the total possible video clips identified from the one or more event indications determined by the server 100, for instance, only video clips of certain event types or those of a certain person/player may be desired to be generated. Additionally, the one or more video clips can be provided by the video capture device 150 as a self-executing video file. Also, pertinent to note is that the one or more video clips can be downloaded to a removable storage device such as but not limited to a USB flash drive. However, the system 75 can also support preparing files for emailing the one or more video clips to the user, posting them on a web page, or other distribution means to provide the user or a group of users with video clips of specific events suited to their interests.

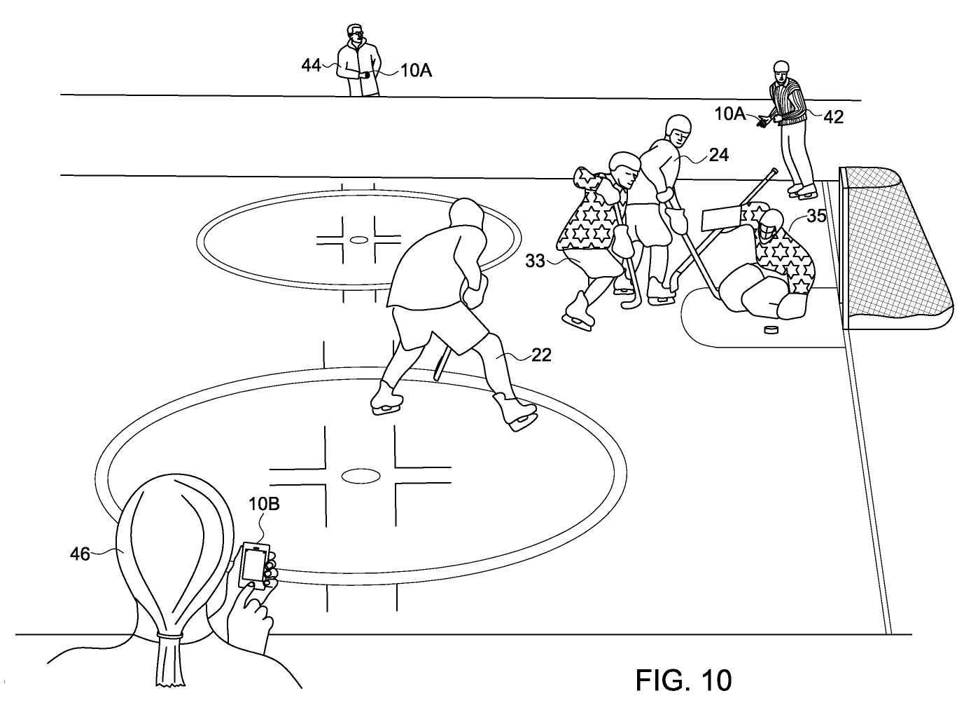

Referring now to FIG. 10, an action scene of a hockey game exemplary of the systems and methods of the one embodiment is shown and is described from the perspective of several typical users of the systems and methods. It is appropriate to note that perspective view of FIG. 10 could be that of a one of the one or more video cameras (180a, 180b, 180c, or 180d momentarily referring back to FIG. 1).

In the action scene, a scoring play comprises a first offensive player 22, a second offensive player 24, a first defensive player 33, and a second defensive player 35 (the goalie). The first offensive player 22 shoots the puck and scores a goal past the second defensive player 35. Also, pertinent to the scoring play is the position and actions of the second offensive player 24 and the first defensive player 33.

A referee 42 may wish to review the scoring play to determine if he correctly made the determination the second offensive player 24 was not in the crease at the time of the goal. The referee 42 therefore makes two successive depressions of his first mobile timestamp device 10a to make an indication of the specific event while keeping his eye on the action and skating toward the goal to ensure that a fight between the first defensive player 33 and the second offensive player 24 does not ensue. In this example, the referee 24 may have previously categorized event type “B” as any infraction related to the goalie and entered very short time parameters, such as 30 seconds before and 45 total seconds for the event time for event type “B”.

Continuing with the example, a coach 44 may have been teaching his players how to set a proper screen and thought the second player 24 executed the screen to perfection during the scoring play. So, the coach 44 makes a single depression on his first mobile timestamp device 10a so that he can quickly review the screen with the team at the next scheduled practice. The coach 44, for instance, may have previously categorized event type “A” as screening plays and entered a slightly longer time parameter to observe how the play developed, such as two minutes before and two minutes and 30 total seconds for the event time for event type “A”.

Also illustrative of the various embodiments is the use of the system and method of a parent 46 watching the game from the stands. Parent 46 has her second mobile timestamp device 10b and wants to obtain a video clip of her son, the first offensive player 22, scoring the goal. Hence, she uses the StatKeeper software application to make one or more event data entries into her second mobile timestamp device 10b for which she can later obtain the video clip of her son and email it to a variety of family members. It is pertinent to note that when utilizing the second mobile timestamp device 10b, it can be enabled for wireless connectivity whereby immediate connectivity to the server 100 may allow video clips to be generated in real-time.

Moreover, each user discussed above (referee 42, coach 44, and parent 46) as well as other users of the system 75 can obtain their own specific video clips from the system 75 for the same game recorded game without being inundated with the video clips of other users. Many other uses by a plurality of other interested persons are contemplated such as, but not limited to, a proprietor of an eatery or pub wishing to attract customers by playing highlight video clips of the game at the establishment shortly after the game, and a scout reviewing the play of a certain player wishing to quickly email video clips to a remote coach.

### Alternate Embodiments and Variations

Alternate embodiments and variations thereof described above are merely exemplary and are not meant to limit the scope of the present invention. It is to be appreciated that numerous alternate embodiments and variations to the system and method described herein have been contemplated as would be obvious to one of ordinary skill in the art with the benefit of this disclosure.

For example, the inventive system may be employed with a video capture device that can record video from any input source such as, but not limited to, off-air television signal receivers, cable access television systems and receivers, satellite television receivers, DVD players, and VHS players. Hence, a user of this embodiment may, for instance, watch pre-recorded home videos on a VHS tape though a VHS player with a mobile timestamp device and select favorite video clips which then can be saved and/or sent to various family members.

Furthermore, the StatKeeper software application typically used in conjunction with the data acquisition device, which is typically a PDA may also reside on a typical computer or accessible via a web page.

Consequently, methods of various embodiments can be implemented: as a sequence of computer-implemented steps running on the system; and/or as interconnected modules within the system. Methods of various embodiments can be implemented on a special purpose computer, a general purpose computer programmed with software designed to execute the processes described herein, and/or a computer-readable storage medium. Furthermore, it is understood that embodiments of the present invention are not limited with regard to any particular network environment or the application used to communicate in that environment. The implementation of the systems and methods of the medication reconciliation system is a matter of choice dependent on the particular performance requirements of the system implementing the methods of the present invention as well as the computer and networking resources available in a given scenario.

It will be recognized by one of ordinary skill in the art that the operations steps and modules can be implemented in software, and firmware, in special-purpose digital logic, analog circuits, and any combination thereof without deviating from the spirit and scope of the present invention as recited within the claims attached hereto. All variations of the invention that read upon the appended claims are intended and contemplated to be within the scope of the present invention.

I claim:

1. A computer-enabled method comprising:
providing a computer system, the computer system comprising,
a video capture device, a server, an event indication software application, and a one of a mobile timestamp device and a software application adapted to record data on a PDA, wherein the video capture system is operatively coupled to the server, the mobile timestamp device is adapted to record one or more event data entries, the event indication software application is accessible by the server, and the event indication software application is adapted to identify an event time and an event type for an event occurrence from the one or more event data entries as recorded by the mobile timestamp device;
synchronizing the one of the mobile timestamp device and the PDA, the video capture device, and the server;
establishing a connection between the one of the mobile timestamp device and the PDA and the server;
collecting one or more event data entries from the one of the mobile timestamp device and the PDA;
determining one or more event indications and the event time and the event type thereof, and
generating one or more video clips for the one or more event indications.

2. The computer-enabled method of claim 1, wherein the system further includes one or more cameras, the one or more cameras being operatively coupled to the video capture device.

3. The computer-enabled method of claim 2, further comprising:
recording a live event, a video of the live event being stored on the video capture device.

4. The computer-enabled method of claim 1, wherein said collecting one or more event data entries includes collecting one or more event data entries created by:
depressing a button on the mobile timestamp device a single time to indicate the event occurrence of a first event type.

5. The computer-enabled method of claim 4, wherein the first event type is one of a goal, a shot attempt, and a penalty.

6. The computer-enabled method of claim 4, wherein said collecting one or more event data entries includes collecting one or more event data entries created by:
depressing the button on the mobile timestamp device two times to indicate an event occurrence of a second event type, wherein a time interval between a first depressing of the button and a second depressing of the button is less than a short time interval; and
depressing the button on the mobile timestamp device three times to indicate the event occurrence of a third event type, wherein the time interval between the first depressing of the button and the second depressing of the button is less than the short time interval, and the time interval between the second depressing of the button and a third depressing of the button is less than the short time interval.

7. The computer-enabled method of claim 1, wherein said collecting one or more event data entries includes collecting one or more event data entries created by:
entering one or more data details into the PDA, the one or more data details comprising information related to a specific event identified by the one or more event indications.

8. The computer-enabled method of claim 7, wherein said entering one or more data details further includes:
entering a first data detail identifying at least one of the one or more event types for the one or more event indications;
entering a second data detail identify a person associated with the at least one of the one or more event types for the one or more event indications; and
entering a third data detail identifying a location of the person during the at least one of the one or more event types for the one or more event indications.

9. The computer-enabled method of claim 1, further comprising:
entering one or more time parameters into the server relating to at least one of the one or more event types.

10. The computer-enabled method of claim 9, wherein said entering one or more time parameters further includes:
entering a first time parameter indicating a first amount of time, the first amount of time being a duration prior to an event time for the at least one of the one or more event indications for which the customized copy from the video capture device should be started; and
entering a second time parameter indicating a second amount of time, the second amount of time being a total duration for the at least one of the one or more event indications for which the customized copy from the video capture device should be recorded.

11. The computer-enabled method of claim 1, wherein said establishing the connection comprises operatively coupling the one of the mobile timestamp device and the PDA to the server through a USB port on the server.

12. The computer-enabled method of claim 1, wherein the one or more video clips comprise at least one self-executing video file.

13. The computer-enabled method of claim 1, further comprising:
transferring the one or more video clips from the server to a removable storage device.

14. A computer system for managing a mobile timestamp device and a video capture device, the computer system comprising:
a server computer, the server computer having,
a processor,
a network connection coupled to the processor, and
one or more storage devices coupled to the processor, the one or more storage devices having stored thereon machine-readable instructions, the instructions when executed by the processor causing the processor to,
record one or more event data entries stored on the mobile timestamp device onto the one or more storage devices, the one or more event data entries including information regarding at least one of: a timestamp, a type of event, a person involved in the event, and a location of the person involved in the event;
compute a event indication, the event indication being determined by one of: (i) identifying a first of a series of successive timestamp data entries and (ii) identifying a timestamp data entry associated with a corresponding type of event data entry; and
compute an event type for the event indication, the event type being determined by one of: (i) counting the series of successive timestamp data entries and (ii) identifying the corresponding type of event data entry associated with the timestamp data entry.

15. The computer system of claim 14, the machine-readable instructions when executed by the processor causing the processor to further:
record one or more time parameters for a particular event type onto the one or more storage devices; and
request a customized copy from the video capture device, the customized copy comprising a time period relating to the event indication, the particular event type, and the one or more time parameters thereof.

16. The computer system of claim 15, wherein at least one of the one or more storage devices includes a removable storage device, and the machine-readable instructions when executed by the processor causing the processor to further:
transfer the customized copy to the removable storage device.

17. A system for generating video clips, the system comprising:
a server;
a data entry device, the data entry device being operatively coupled to the server;
a video capture device, the video capture device being operatively coupled to the server; and
a mobile timestamp device, the mobile timestamp device being removably coupled to the server;
wherein the server is adapted to: (i) synchronize the mobile timestamp recorder with the video capture device, (ii) receive and store one or more event data entries from the mobile timestamp device, (iii) receive and store one or more time parameters associated with each event type, and (iv) request a customized copy from the video capture device for each of the one or more event indications with the associated one or more time parameters.

18. The system of claim 17, further comprising:
one or more video cameras, the one or more video cameras being operatively coupled to the video capture device.

19. The system of claim 17, further comprising:
a wireless router, the wireless router providing the operative coupling between the video capture device and the server.

20. The system of claim 17, wherein the customized copy from the video capture system is a self-executing video file.

21. A mobile timestamp device comprising:
a housing;
a battery;
a button;
a time clock circuit; and
a memory, the memory being adapted to store a timestamp if the button is depressed.

22. The mobile timestamp device of claim 21, further comprising an interface, and wherein the mobile timestamp device is adapted to be held in one hand and the button depressed by the one hand.
